(19) United States
(12) Patent Application Publication
(10) Pub. No.: US 2013/0034213 A1
(43) Pub. Date: Feb. 7, 2013

(54) METHOD AND SYSTEM FOR MONITORING MISHANDLING OF A DIGITAL X-RAY DETECTOR

(71) Applicants: James Zhengshe Liu, Glenview, IL (US); Chuande Liu, Waukesha, WI (US); Nicholas Ryan Konkle, Waukesha, WI (US); Tan Liu, Brookfield, WI (US); Roy Allan Schley, Milwaukee, WI (US)

(72) Inventors: James Zhengshe Liu, Glenview, IL (US); Chuande Liu, Waukesha, WI (US); Nicholas Ryan Konkle, Waukesha, WI (US); Tan Liu, Brookfield, WI (US); Roy Allan Schley, Milwaukee, WI (US)

(73) Assignee: General Electric Company, Schenectady, NY (US)

(21) Appl. No.: 13/204,516

(22) Filed: Aug. 5, 2011

(51) Int. Cl. H05G 1/64

(52) U.S. Cl. 378/98.5; 378/98.8

(57) ABSTRACT

A digital X-ray detector includes a shock monitoring system configured to monitor for an occurrence of a shock event via at least one shock sensor. The detector also includes a processor configured to receive information related to the shock event from the shock monitoring system and to report the shock event to an X-ray system communicatively coupled to the detector.

### BACKGROUND OF THE INVENTION

The subject matter disclosed herein relates to X-ray imaging systems, and particularly to monitoring of mishandling of a digital X-ray detector of such systems.

The advent of digital X-ray detectors has brought enhanced workflow and high image quality to medical imaging. In the current state of the art medical imaging environments, X-ray imaging systems include an imaging subsystem and a detector. The imaging subsystem may be fixed or mobile and may use a detachable or wireless detector. The detachable or wireless X-ray detector makes the detector more portable for even greater versatility. However, with increased portability of the digital X-ray detectors comes a greater opportunity for mishandling of the detectors, potential damage to the detectors resulting from mishandling, and increased costs to warrantees of the detectors. Thus, there is a need for a system to monitor and report mishandling incidents that may result in damage to the detectors.

### BRIEF DESCRIPTION OF THE INVENTION

In accordance with one embodiment, a digital X-ray detector includes a shock monitoring system configured to monitor for an occurrence of a shock event via at least one shock sensor. The detector also includes a processor configured to receive information related to the shock event from the shock monitoring system and to report the shock event to an X-ray system communicatively coupled to the detector.

In accordance with another embodiment, an X-ray system includes an X-ray detector that includes a shock monitoring system configured to monitor for an occurrence of a shock event to the detector via at least one shock sensor and a main processor configured to receive information related to the shock event from the shock monitoring system and to report the shock event to an imaging system communicatively coupled to the detector. The X-ray system also includes the imaging system that includes a processor configured to receive the information related to the shock event and a display configured to provide a user-viewable warning of the shock event.

In accordance with a further embodiment, a method for analyzing mishandling of a digital X-ray detector includes detecting a shock event to the detector via a shock monitoring system. The method also includes analyzing the shock event to determine a severity of the shock event and reporting the shock event to an X-ray system communicatively coupled to the detector. The method further includes providing a user-viewable warning of the shock event to an operator of the X-ray system.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical overview of an exemplary digital X-ray system in the which the present technique may be utilized;

FIG. 2 is a diagrammatical representation of components in a detector of the system of FIG. 1;

FIG. 3 is a flow diagram of an exemplary method for monitoring mishandling of the detector;

FIG. 4 is a flow diagram of an exemplary method for monitoring and analyzing shock events to the detector;

FIG. 5 is an example of a screen having a warning for a current low-level shock event;

FIG. 6 is an example of a screen having a warning for a past low-level shock event;

FIG. 7 is an example of a screen having a warning for a current high-level shock event; and

FIG. 8 is an example of a screen having a warning for a past high-level shock event.

### DETAILED DESCRIPTION OF THE INVENTION

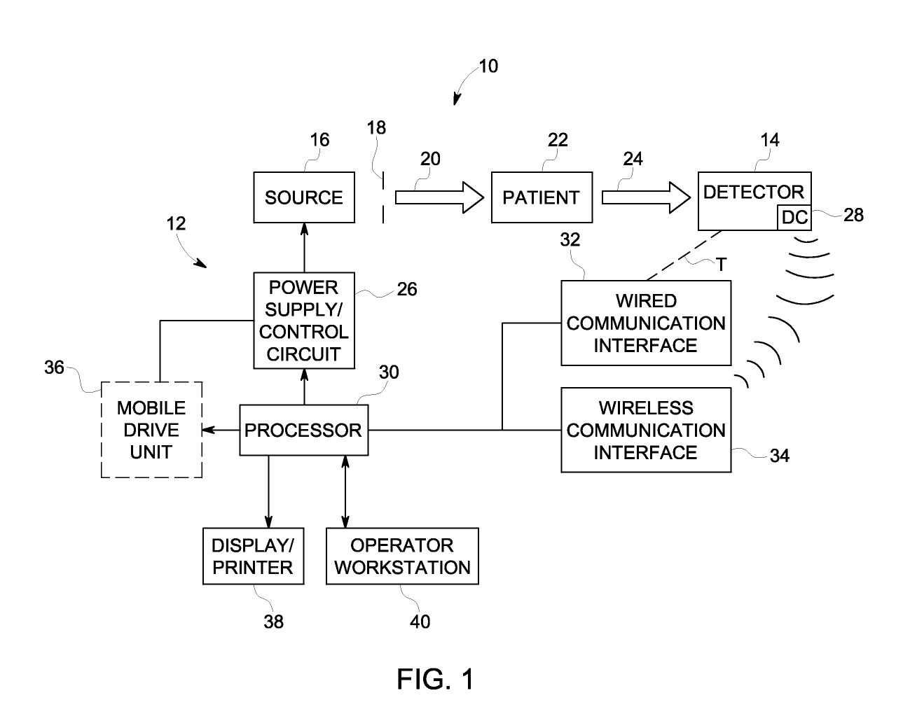

Turning now to the drawings, FIG. 1 illustrates diagrammatically an X-ray system 10 for acquiring and processing discrete pixel image data. The X-ray system 10 may be a fixed or mobile imaging system. In the illustrated embodiment, the X-ray system 10 is a digital X-ray system designed both to acquire original image data and to process the image data for display in accordance with the present technique. Throughout the following discussion, however, while basic and background information is provided on the digital X-ray system used in medical diagnostic applications, it should be borne in mind that aspects of the present techniques may be applied to digital detectors, including X-ray detectors, used in different settings (e.g., projection X-ray, computed tomography imaging, tomosynthesis imaging, etc.) and for different purposes (e.g., parcel, baggage, vehicle and part inspection, etc.).

In the embodiment illustrated in FIG. 1, the X-ray system 10 includes an imaging system 12 and a portable radiographic device or detector 14 (e.g., digital X-ray detector). As described in greater detail below, the detector 14 includes a shock monitoring system to monitor mishandling of the detector 14. In particular, the shock monitoring system monitors for an occurrence of a shock event to the detector 14 via at least one shock sensor. The detector 14 reports significant shock events to the X-ray system 10, particularly to the imaging system 12, which in turn reports these shock events to a warrantee service system to track the shock events associated with the detector 14. In addition, the X-ray system 10 (i.e., the imaging system 12 and/or the detector 14) provides warnings to an operator of significant shock events and potential damage to the detector 14. In certain embodiments, the X-ray system 10 prompts the operator to initiate an analysis (e.g., quality assurance process (QAP)) of the detector 14 for potential damage. The X-ray system 10 (i.e., imaging system 12) may also report a damaged detector 14 to a service system for repair.

The imaging system 12 includes a source 16 of X-ray radiation positioned adjacent to a collimator 18. The collimator 18 permits a stream of radiation 20 to pass into a region in which an object or subject, such as a patient 22, is positioned. A portion of the radiation 24 passes through or around the subject and impacts the digital X-ray detector 14. As will be appreciated by those skilled in the art, the detector 14 may convert the X-ray photons received on its surface to lower energy photons, and subsequently to electric signals, which are acquired and processed to reconstruct an image of the features within the subject.

The radiation source 14 is controlled by a power supply/control circuit 26 which supplies both power and control signals for examination sequences. Moreover, the detector 14 is communicatively coupled to a detector controller 28 which commands acquisition of the signals generated in the detector 14. The detector controller 28 may also execute various signal processing and filtration functions, such as for initial adjustment of dynamic ranges, interleaving of digital image data, and so forth. The detector controller 28 is responsive to signals from a processor 30 communicated via a multi-conductor cable or tether via a wired communication interface 32 or communicate wirelessly via a wireless communication interface 34.

Both the power supply/control circuit 26 and the detector controller 28 are responsive to signals from the processor 30. In general, the processor 30 commands operation of the imaging system 12 to execute examination protocols and to process acquired image data. In addition, the processor 30 is configured to receive information related to the shock event from the detector 14 and to log the information in a log file. Further, the processor 30 is configured to perform the QAP to analyze the detector 14 for potential damage. In certain embodiments, the processor 30 is configured to inhibit an exposure from the source 16 (via the power supply/control circuit 26) in response to a high-level shock event (e.g., 150 G or greater) reported from the detector 14 until performance of the QAP verifies that the detector 14 is free of damage. Yet further, the processor 30 may report the high-level shock event to a warrantee service system and/or the condition (e.g., damage) of the detector 14 to a service system. In mobile imaging systems, the processor 30 also commands operation of a mobile drive unit 36 of a wheeled base. In the present context, the processor 30 also includes signal processing circuitry, typically based upon a programmed general purpose or application-specific digital computer; and associated memory circuitry, such as optical memory devices, magnetic memory devices, or solid-state memory devices. The memory circuitry allows for storing programs and routines executed by a processor of the computer to carry out various functionalities, as well as for storing configuration parameters and image data; interface circuits; and so forth.

In the embodiment illustrated in FIG. 1, the processor 30 is linked to at least one output device, such as a display or printer, as indicated at reference numeral 38. The output device may include standard or special purpose computer monitors and associated processing circuitry. The display 38 may be used to provide a user-viewable warning of the occurrence of the shock event and/or potential damage to the detector 14. One or more operator workstations 40 may be further linked in the system for outputting system parameters, requesting examinations, viewing images, initiating the QAP to assess potential damage to the detector 14, and so forth. In general, displays, printers, workstations, and similar devices supplied within the system may be local to the data acquisition components, or may be remote from these components, such as elsewhere within an institution or hospital, or in an entirely different location, linked to the image acquisition system via one or more configurable networks, such as the Internet, virtual private networks, and so forth.

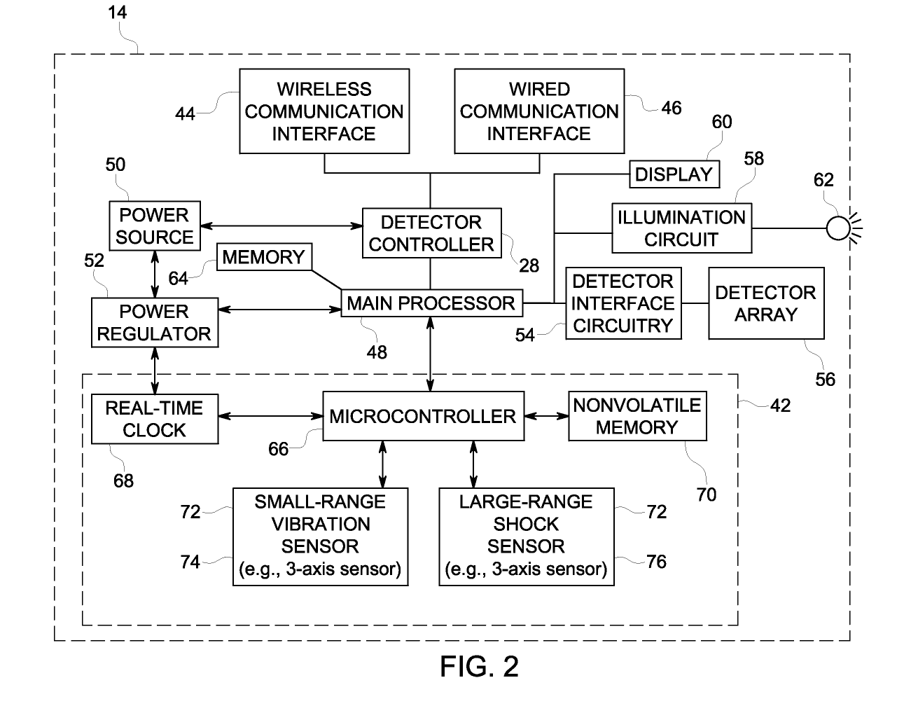

FIG. 2 illustrates the components of the detector 14 having a shock monitoring system 42. As mentioned above, the detector 14 includes the detector controller 28. The detector 14 also includes, coupled to the detector controller 28, a wireless communication interface 44 for wireless communication with the X-ray system 10 (e.g., imaging system 12), as well as a wired communication interface 46, for communicating with the detector 14 when it is tethered to the imaging system 12. The detector 14 may also be in communication with a server. It is noted that the wireless communication interface 44 may utilize any suitable wireless communication protocol, such as an ultra wideband (UWB) communication standard, a Bluetooth communication standard, or any 802.11 communication standard.

The detector controller 28 is linked to a processor 48 (e.g., main processor). The processor 48, the detector controller 28, the shock monitoring system 42, and all of the circuitry receive power from a power source 50. The power source 50 may include a battery (e.g., rechargeable battery). Alternatively, the detector 14, including the power source 50, may receive power from a power supply of the imaging system 12 when tethered. The power source 50 is coupled to a power regulator 52 which determines the power state (e.g., active state and/or sleep state) of the processor 48 and components of the shock monitoring system 42 (e.g., microcontroller).

Also, the processor 48 is linked to detector interface circuitry 54. The detector 14 converts X-ray photons received on its surface to lower energy photons. The detector 14 includes a detector array 56 that includes an array of photodetectors to convert the light photons to electrical signals. Alternatively, the detector 14 may convert the X-ray photons directly to electrical signals. These electrical signals are converted to digital values by the detector interface circuitry 54 which provides the values to the processor 48 to be converted to imaging data and sent to the X-ray system 10 (e.g., imaging system 12) to reconstruct an image of the features within a subject. Alternatively, the imaging data may be sent from the detector 14 to a server to process the imaging data.

The processor 48 is also linked to an illumination circuit 58 and display 60. The processor 48, in response to information received from the shock monitoring system 42, may signal the illumination circuit 58 to illuminate a light 62 (e.g., light emitting diode (LED)) of the detector 14 to indicate a status of the detector 14. The detector controller 28, in response to a signal from the X-ray system 10 (e.g., imaging system 12) indicating damage to the detector 14, may send a signal to the processor 48 to signal the illumination circuit 58 to illuminate the light 62 to indicate the status of the detector 14. For example, the status may indicate the occurrence of the shock event and/or damage to the detector 14. Also, the light 62 may illuminate different colors representative of the severity of the shock event and/or the damage to the detector 14. Thus, the illumination of the light 62 may act a user-viewable warning. In certain embodiments, the processor 48 may also provide the status of the detector 14 (e.g., user-viewable warning) via the display 60 (e.g., LCD display). Examples of warnings displayed on the display 60 are discussed in greater detail below.

Further, the processor 48 is linked to a memory 64. The memory 64 may store various configuration parameters, calibration files, and detector identification data. The memory 64 may also store information received from the shock monitoring system 42 such as peak shock values and a timestamp associated with each shock event. In addition, the memory 64 may store predetermined thresholds for classifying the severity of each shock event and/or determining whether the shock event is to be recorded and/or reported. For example, the memory 64 may store a threshold for determining whether the shock event should be recorded or ignored (e.g., 50 G). In addition, the memory 64 may store thresholds to determine if the shock event should only be recorded (e.g., 50 G to 100 G) or a warning also given to the operator (e.g., 100 G or above). Further, the memory 64 may store thresholds to distinguish between a low-level shock event (e.g., 100 G to 150 G) or a high-level shock event (e.g., greater than 150 G). The thresholds given are only examples and may vary depending on various factors such as the type and design of the detector 14.

Yet further, the processor 48 is linked to the shock monitoring system 42 via a microcontroller 66. The shock monitoring system 42 comprises the microcontroller 66 (e.g., low power microcontroller), a real-time clock 68, a nonvolatile memory 70, and a plurality of shock sensors 72. The shock monitoring system 42 monitors for an occurrence of the shock event to the detector 14 via the plurality of shock sensors 72. In particular, the microcontroller 44 monitors the plurality of shock sensors 72. The plurality of shock sensors 72 include 3-axis (e.g., x-, y-, and z-axes) shock sensors configured to measure shock values along each axis. The plurality of shock sensors 72 includes at least one small-range vibration sensor 74 and at least one large-range shock sensor 76. In certain embodiments, the plurality of sensors 72 may include more than two shock sensors 72, more than one small-range vibration sensor 74, and/or more than one large-range shock sensor 76. The small-range vibration sensor 74 is more sensitive to the beginning of the shock event. For example, the small-range vibration sensor 74 may sense vibrations or shock events up to 16 G. The large-range shock sensor 76 may sense shock events ranging from 300 G to 500 G.

In order to save power, the detector 14 maintains, via the power regulator 52, the microcontroller 66 in a sleep mode. In response to sensing vibrations or the beginning of the shock event, the microcontroller 66 is awoken from the sleep mode to an active state (e.g., full monitoring mode). The microcontroller 66 monitors 3-D peak shock values (i.e., peak shock values along the x-, y-, and z-axes) of the large-range shock sensor 76 and compares the peak shock values to predetermined thresholds stored in the nonvolatile memory 70. The thresholds stored are similar to those stored in the memory 64. The microcontroller 66 records information related to the shock event if a single shock value exceeds a predetermined threshold (e.g., 50 G) for recording the shock event (e.g., 50 G). The microcontroller 66 may not record shock events below the predetermined threshold for recording. The microcontroller 66 records 3-D peak shock values (i.e., peaks shock values for each axis) and a timestamp in the nonvolatile memory 70. The microcontroller 66 acquires the timestamp from the real-time clock 68 and includes a year, month, data and time of the shock event. The X-ray system 10 updates the real-time clock 68 each time the detector 14 establishes communication with the X-ray system 10 (e.g., imaging system 12). Updating the real-time clock 68 enables adjustment of the clock 68 for time zone differences.

If the processor 48 is active when the shock event occurs, the microcontroller 66 reports the information related to the shock event to the processor 48 immediately and the microcontroller 66 returns to sleep mode. If the processor 48 is inactive, the microcontroller 66 flags the information related to the shock event in the nonvolatile memory 70 for reporting to the processor 48. Once the processor 48 shifts from an inactive state to an active state and communication is established between the detector 14 and X-ray system 10 (e.g., imaging system 12), the processor 48 shifts the microcontroller 66 from the sleep mode to the active state via the power regulator 52. The microcontroller 66, upon activation, checks the nonvolatile memory 70, reports any shock event related information flagged for reporting, clears the flag associated with the information, and then returns to sleep mode.

The processor 48 compares the information (e.g., peak shock values) related to the shock event from the microcontroller 66 to thresholds stored in the memory 64 or provided by the nonvolatile memory 70. In particular, the processor 48 is configured to analyze the received information related to the shock event and assign a warning level based on the received information. As mentioned above, the thresholds given are only examples and may vary depending on various factors such as the type and design of detector 14. For example, the processor 48 compares the peak shock values to a predetermined threshold (e.g., 100 G) for issuing a warning of the occurrence of the shock event. If the peak shock values fall below 100 G, no warning is assigned to the shock event. If the peak shock values are equal to or greater than 100 G than a warning level is assigned to the shock event. Also, the processor 48 compares the peak shock values to a predetermined threshold (e.g., 150 G) for classifying the shock event as a low-level shock event (e.g., 100 G to less than 150 G) or high-level shock event (e.g., 150 G or greater). High-level shock events are associated with potential damage to the detector 14 (e.g., damage to the detector array 56). The processor 48 reports the information related to the shock events (e.g., timestamp, peak shock values, associated warning level) to the X-ray system 10 (e.g., imaging system 12) communicatively coupled to the detector 14. As mentioned above, high-level shock events trigger the inhibition of exposure from the source 16 of the imaging system 12, while the detector 14 is analyzed for potential damage via the QAP.

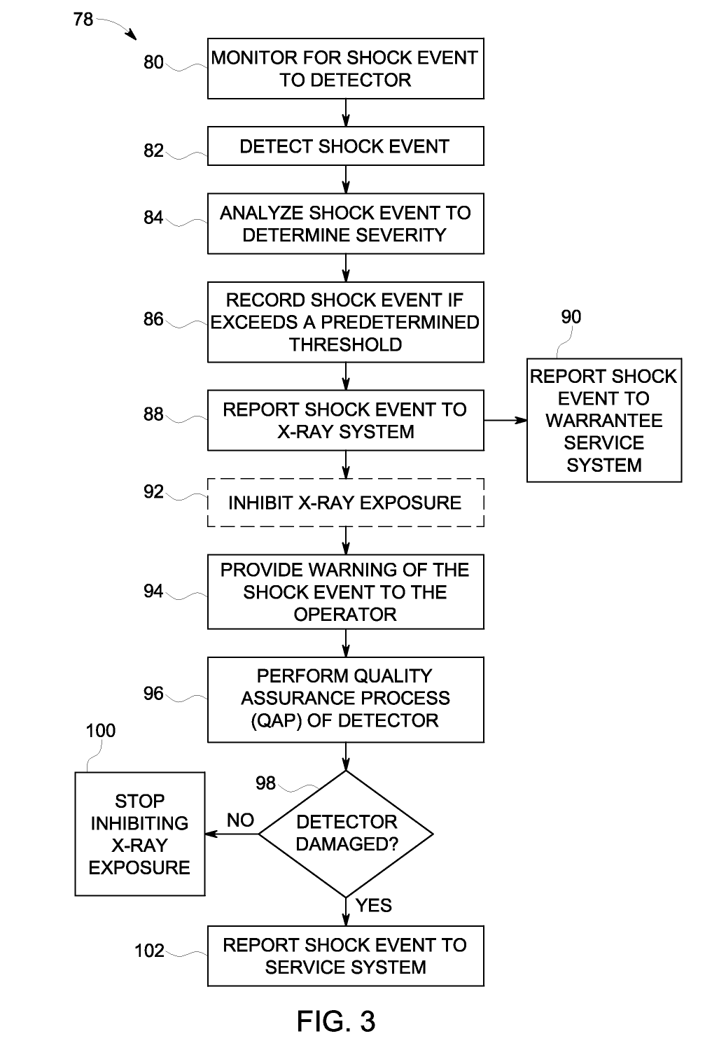

FIG. 3 illustrates a flow diagram of an exemplary method 78 for monitoring mishandling of the detector 14. The method 78 includes monitoring for shock events to the detector 14 (block 80). As described above, the shock monitoring system 42 monitors for the occurrence of shock events using the plurality of shock sensors 72. The method 78 also includes detecting the shock events (block 82). As mentioned above, the small-range vibration sensor 74 may initially detect the beginning of the shock event due to its increased sensitivity compared to the large-range shock sensor 76. Upon detecting the occurrence of the shock event (block 82), the method 78 includes analyzing the shock event to determine the severity of the shock event (block 84). Analyzing the shock event includes comparing peak shock values acquired from the large-range shock sensor 76 to predetermined thresholds to determine the severity of the shock event as described above. The method 78 further includes recording the shock event (e.g., via the microcontroller 66 in the nonvolatile memory 70 or processor 48 in memory 64) if at least one of the peak shock values for an axis exceeds the predetermined threshold (e.g., 50 G) for recording (block 86). If the peak shock values for the shock event fall below the predetermined threshold for recording, the microcontroller 66 ignores the shock event (block 114). The recorded information related to the shock event may include a timestamp, peak shock values, and/or an associated warning level.

The method 78 also includes reporting the shock event to the X-ray system 10 (e.g., imaging system) communicatively coupled to the detector 14 (block 88). The reported shock event is recorded by the processor of the imaging system 12 into the log file. In the case of high-level shock events (e.g., 150 G or greater), the X-ray system 10 (e.g., imaging system 12) reports the shock event to a warrantee service system (block 90). The warrantee service system may track the shock event related information for the detector 14 as well shock event information gathered from other detectors 14. Also, in the case of high-level shock events, the imaging system 12 may inhibit the exposure from the source 16 of X-ray radiation (block 92). For both low- and high-level shock events, the method 78 includes providing a warning (e.g., user-viewable warning) of the shock event to the operator (block 94) via the light 62 or display 60 on the detector 14 or via the display 38 on the imaging system 12. In the case of high level shock events, the warning may provide an indication to an operator to perform the QAP to assess damage to the detector 14 (block 96). Upon performing the QAP (block 96), the method 78 includes determining whether the detector 14 is damaged (block 98). If the QAP finds the detector 14 did not acquire damage, then the imaging system 12 stops inhibiting the X-ray exposure (block 100) and the detector 14 may be used. However, if the QAP finds the detector 14 acquired damage, the X-ray system 10 reports the shock event and detector damage to a service system (block 102). In certain embodiments, the X-ray system 10 prompts the operator to also contact a service engineer to repair the detector 14.

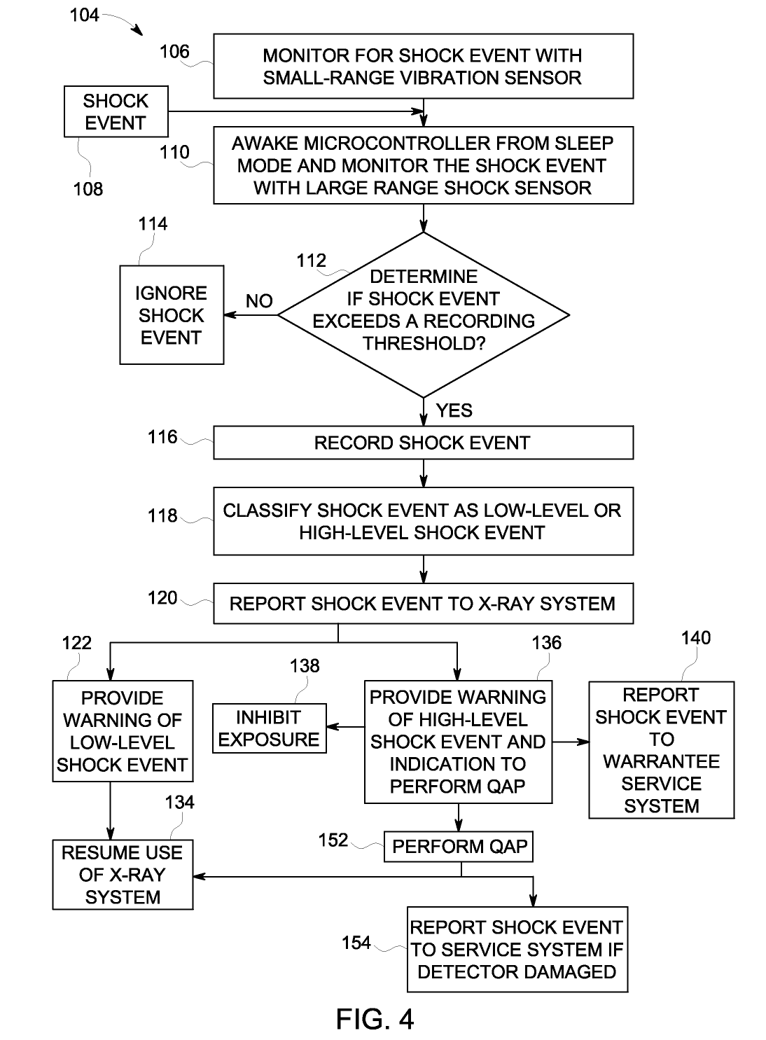

FIG. 4 is a flow diagram of an exemplary method 104 for monitoring and analyzing shock events to the detector 14. The method 104 includes monitoring for the occurrence of the shock event 106 with the small-range vibration sensor 74 of the shock monitoring system 42 (block 106) while the microcontroller 66 maintains a sleep mode. The occurrence of the shock event 108 awakens the microcontroller 66 from the sleep mode and the microcontroller continues to monitor the shock event 108 with the large-range shock sensor 76 (block 110). The method 104 also includes the microcontroller 66 determining if the shock event 108 exceeds a recording threshold (block 112). If the peak shock values of the shock event 108 do not exceed the recording threshold (e.g., 50 G), the microcontroller 66 ignores the shock event 108 (block 114). If at least one peak shock value along one axis exceeds the recording threshold, the microcontroller 66 records the shock event 108 (block 116). If the processor 48 of the detector 14 is inactive during the shock event 108, the microcontroller 66 flags the shock event 108 for recording once the processor 48 is active and the detector 14 is communicatively coupled to the X-ray system 10 (e.g., imaging system 12). If the processor 48 of the detector 14 is active during the shock event 108, the microcontroller 66 reports the information related to the shock event 108 to the processor 48. The method 104 further includes classifying the shock event 108 as a low-level shock event (100 G to less than 150 G) or a high-level shock event (150 G or greater) (block 118). The classification may be based on comparison of the peak shock values to predetermined thresholds as described above. The classification of the shock event 108 (block 118) may occur simultaneously with determining if the shock event 108 should be recorded (block 112).

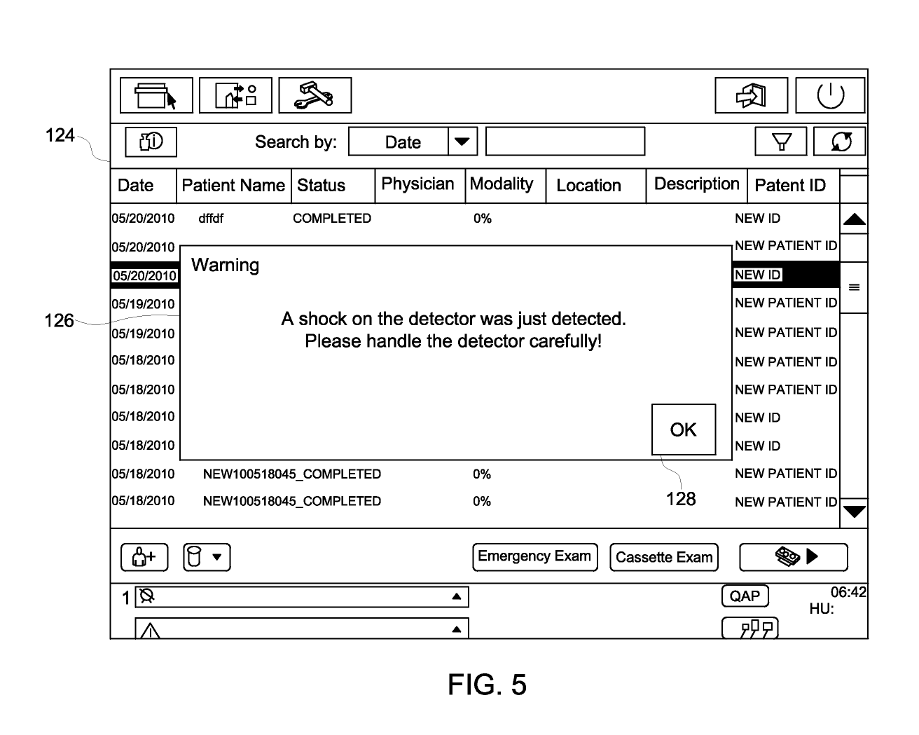

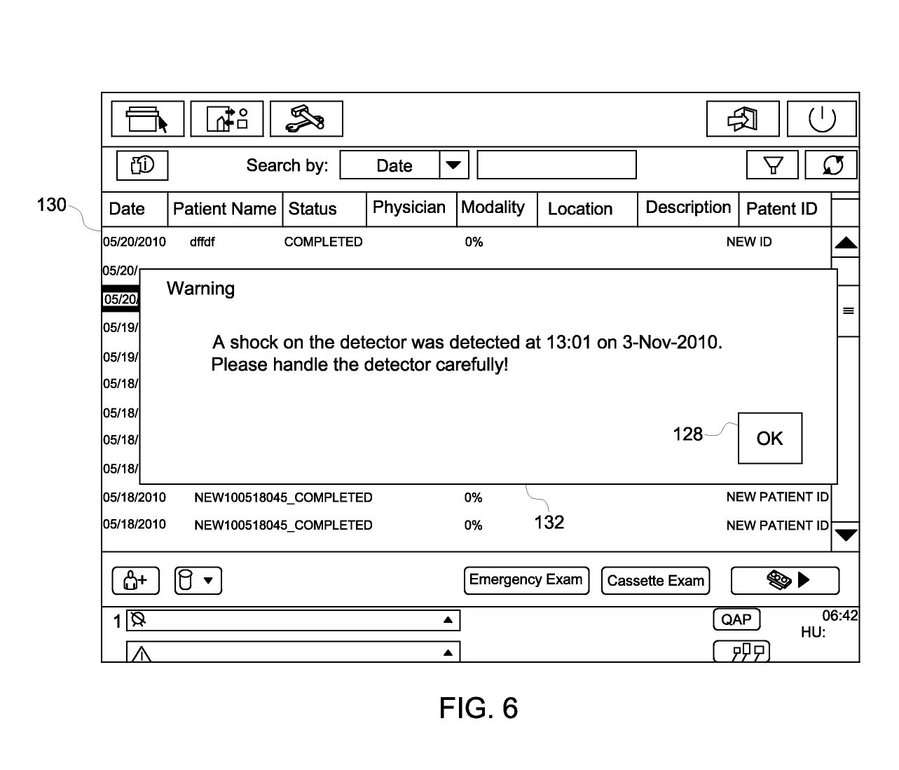

Upon being communicatively coupled to the X-ray system 10 (e.g., imaging system 12), the method 104 includes reporting the shock event 108 to the X-ray system 10 (block 120). After reporting the shock event 108 (block 120), the X-ray system 10 records the shock event 108 in the log file. If the shock event 108 is classified as a low-level shock event, the method 104 includes providing only a user-viewable warning of the shock event 108 to an operator of the X-ray system 10. FIG. 5 illustrates an example of a screen 124 having a warning message 126 of a low-level shock event that occurred while the detector 14 is communicatively coupled to the X-ray system 10 (e.g., imaging system 12). The warning message 126 includes a prompt 128 (e.g., “OK” button) for the operator to acknowledge the message 126. FIG. 6 illustrates an example of a screen 130 having a warning message 132 of a low-level shock event that occurred while the detector 14 was not communicatively coupled to the X-ray system 10 (e.g., imaging system 12). The warning message 132 also includes the prompt 128 for the operator to acknowledge the message 132. These warning messages 126 and 132 may be displayed on the display 38 of the imaging system 12 and/or on the display 60 of the detector 14. Also, the detector 14 may indicate the occurrence of the low-level shock event via the light 62 on the detector 14 as described above. Upon clicking the prompt 128 on the messages 126 and 132, the method 104 includes resuming the use of the X-ray system 10 (block 134).

If the shock event 108 is classified as a high-level shock event, the method 104 includes providing a user-viewable warning of the shock event 108 to an operator of the X-ray system 10 along with an indication to perform the QAP on the detector 14 to assess the potential damage (block 136). The method 104 also includes inhibiting an exposure from the source 16 of X-ray radiation of the imaging system 12 until performance of the QAP verifies the detector 14 is free of damage (block 138). Further, the method 104 also includes reporting the high-level shock event to the warrantee service system (block 140).

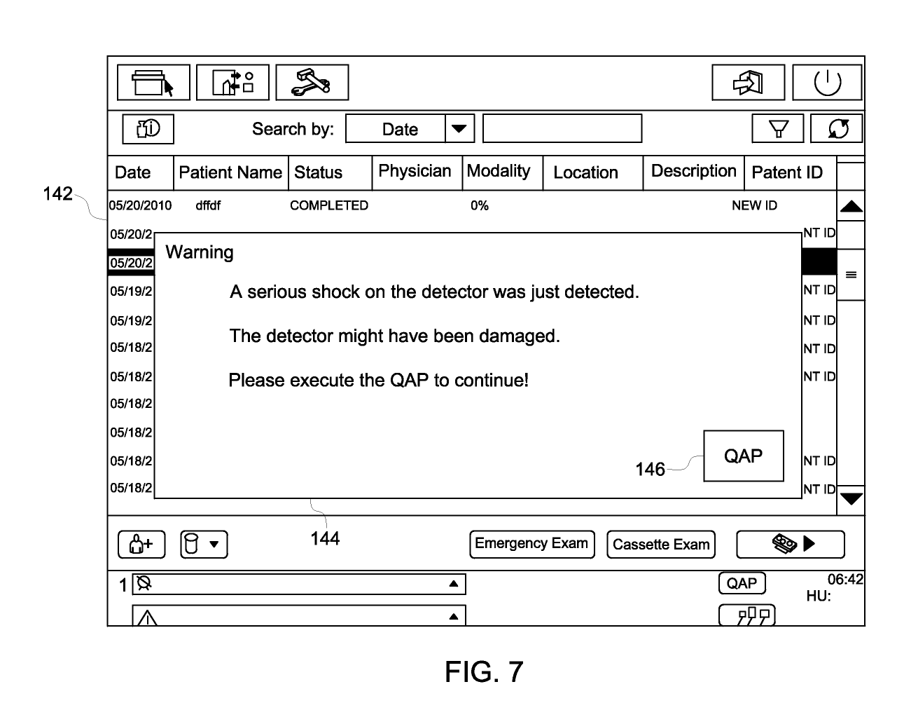

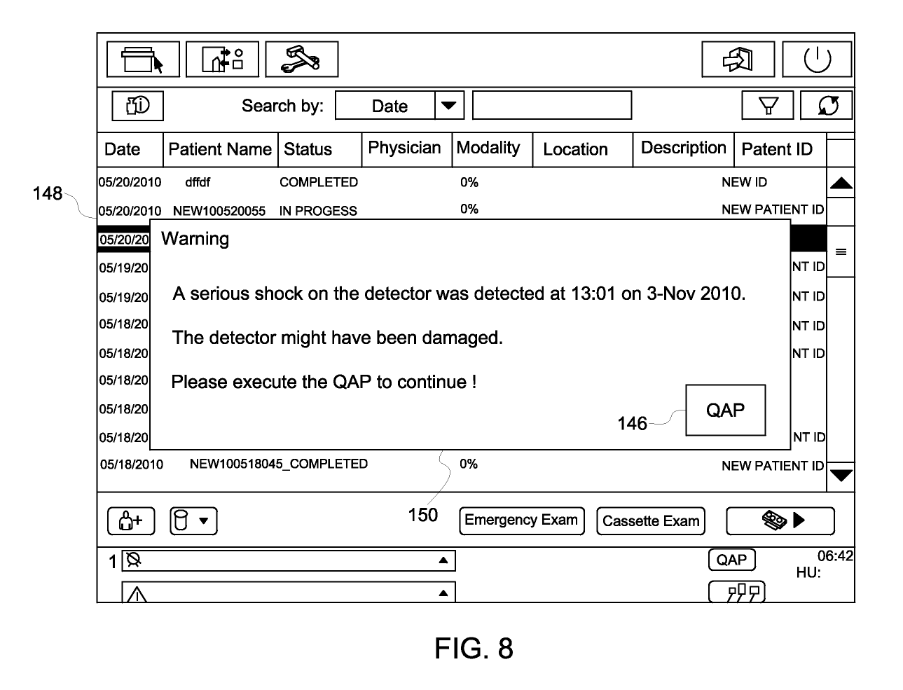

FIG. 7 illustrates an example of a screen 142 having a warning message 144 of a high-level shock event that occurred while the detector 14 is communicatively coupled to the X-ray system 10 (e.g., imaging system 12). The warning message 144 includes a prompt 146 (e.g., “QAP” button) for the operator to perform the QAP to assess any potential damage to the detector 14. FIG. 8 illustrates an example of a screen 148 having a warning message 150 of a high-level shock event that occurred while the detector 14 was not communicatively coupled to the X-ray system 10 (e.g., imaging system 12). The warning message 150 also includes the prompt 146 for the operator to acknowledge the message 150. As mentioned above, these warning messages 144 and 150 may be displayed on the display 38 of the imaging system 12 and/or on the display 60 of the detector 14. Also, the detector 14 may indicate the occurrence of the high-level shock event via the light 62 on the detector 14 as described above. Upon clicking the prompt 146 on the messages 144 and 150, the method 104 includes performing the QAP to determine any potential damage to the detector 14 (block 152). If the QAP finds the detector 14 did not acquire damage, then the imaging system 12 stops inhibiting the X-ray exposure and the operator may resume the use of the X-ray system 10 (block 134). However, if the QAP finds the detector 14 acquired damage, the X-ray system 10 reports the shock event and detector damage to a service system (block 154). In certain embodiments, the X-ray system 10 prompts the operator to also contact a service engineer to repair the detector 14.

Technical effects of the disclosed embodiments include providing a system and method for monitoring the mishandling of the digital X-ray detectors 14. In particular, the detector 14 includes the shock monitoring system 42 to monitor for and detect shock events 108 to the detector 14. The shock monitoring system 42 records significant shock events 108. The detector 14 also determines if the shock event 108 is severe enough (e.g., low-level and high-level shock events) to report the shock event 108 to the X-ray system 10 (e.g., imaging system) along with a warning level associated with the shock event 108. The X-ray system 10 and/or detector 14 may prompt the operator to assess any potential damage to the detector 14. Also, the X-ray system 10 may report the shock event 108 to the warrantee service system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A digital X-ray detector comprising:
a shock monitoring system configured to monitor for an occurrence of a shock event to the detector via at least one shock sensor; and
a processor configured to receive information related to the shock event from the shock monitoring system and to report the shock event to an X-ray system communicatively coupled to the detector.

2. The detector of claim 1, wherein the at least one shock sensor comprise 3-axis shock sensor.

3. The detector of claim 1, the detector comprising a plurality of shock sensors, and the plurality of shock sensors comprise at least one small-range vibration sensor and at least one large-range shock sensor.

4. The detector of claim 1, wherein the shock monitoring system comprises a microcontroller, a real-time clock, and a nonvolatile memory, and the microcontroller is configured to monitor the at least one shock sensor, to record 3-D peak shock values and timestamp for the shock event in the nonvolatile memory, and to report the shock event to the processor.

5. The detector of claim 4, wherein the microcontroller is configured to record the shock event if a single peak shock value in a single axis exceeds a predetermined threshold.

6. The detector of claim 4, wherein the at least one sensor comprises a small-range vibration sensor, and the microcontroller is configured to be in a sleep mode and to be awoken from the sleep mode to a full monitoring mode in response to the small-range vibration sensor sensing the shock event.

7. The detector of claim 4, wherein the microcontroller is configured to report the shock event immediately to the processor if the processor is active.

8. The detector of claim 4, wherein the microcontroller is configured to flag the shock event for subsequent reporting to the processor upon activation of the processor if the processor is inactive at time of shock event and to enable sleep mode after flagging the shock event.

9. The detector of claim 1, wherein the processor is configured to analyze the received information related to the shock event and assign a warning level based on the received information.

10. The detector of claim 9, wherein the warning level indicates a high-level shock event and potential damage to the detector due to the high-level shock event.

11. The detector of claim 9, wherein the warning level is determined based on peak shock values of the shock event.

12. The detector of claim 11, wherein the warning level comprises a low-level shock event based on the peak shock values exceeding only a first predetermined threshold or a high-level shock event based on the peak shock values exceeding a second predetermined threshold greater than the first predetermined threshold.

13. An X-ray system comprising:
an X-ray detector comprising a shock monitoring system configured to monitor for an occurrence of a shock event to the detector via at least one shock sensor and a main processor configured to receive information related to the shock event from the shock monitoring system and to report the shock event to an imaging system communicatively coupled to the detector; and
the imaging system comprising a processor configured to receive the information related to the shock event and a display configured to provide a user-viewable warning of the shock event.

14. The X-ray system of claim 11, wherein the user-viewable warning indicates a low-level shock event to the detector.

15. The X-ray system of claim 11, wherein the user-viewable warning indicates a high-level shock event and potential damage to the detector due to the high-level shock event.

16. The X-ray system of claim 13, wherein the user-viewable warning provides an indication to an operator to perform a quality assurance process to assess damage to the detector.

17. The X-ray system of claim 13, wherein the processor is configured to inhibit an exposure from a source of X-ray radiation of the imaging system due to the high-level shock event until performance of the quality assurance process verifies the detector is free of damage.

18. The X-ray system of claim 13, wherein the imaging system is configured to report the high-level shock event to a warrantee service system.

19. A method for analyzing mishandling of a digital X-ray detector comprising:
detecting a shock event to the detector via a shock monitoring system;
reporting the shock event to an X-ray system communicatively coupled to the detector; and
providing a user-viewable warning of the shock event to an operator of the X-ray system.

20. The method of claim 19, wherein the shock monitoring system comprises a plurality of shock sensors, the plurality of shock sensors comprising at least one small-range vibration sensor and at least one large-range shock sensor, the small-range vibration sensor is configured to initially detect the shock event, and the large-range sensor is configured to subsequently monitor the shock event.

21. The method of claim 19, the method comprising recording peak shock values and a timestamp for the shock event.

22. The method of claim 19, the method comprising analyzing the shock event to determine a severity of the shock event.

23. The method of claim 22, wherein analyzing the shock event comprises comparing peak shock values to predetermined thresholds to determine the severity of the shock event.

24. The method of claim 22, the method comprising inhibiting an exposure from a source of X-ray radiation of the X-ray system due to the severity of the shock event until a quality assurance process verifies the detector is free of damage.

25. The method of claim 24, wherein the user-viewable warning provides an indication to an operator to perform the quality assurance process to assess damage to the detector.
